(19) United States
(12) Patent Application Publication
(10) Pub. No.: US 2008/0202701 A1
(43) Pub. Date: Aug. 28, 2008

(54) See-out, no-see-in, blind for a window, door, or room partition, or in short a noseein.

(76) Inventor: Hugh Rance, Flushing, NY (US)

Correspondence Address: HUGH RANCE, APT 11H, 43-10 KISSENA BLVD, FLUSHING, NY, 11355, US

(21) Appl. No.: 11/556,166

(22) Filed: Nov. 2, 2006

(51) Int. Cl. E06B 9/26

(52) U.S. Cl. 160/166.1

(57) ABSTRACT

A semi-mirrored translucent surface is angled so that when looking towards it from one side (from the outside) one sees the reflection of an illuminated surface that is brighter than what is beyond (the inside) and when looking towards it from the other side (from the inside) one's view through is not blocked by the reflection of a dark surface. The effect is that looking in from the outside, one sees what appear to be illuminated closed blinds and looking out from the inside one sees through what appear to be open slats.

The noseein is a system of slats that

a) enables a viewer to see out through what looks like open venetian blinds, and

b) blocks a viewer from seeing in by presenting what looks like, lighted, closed venetian blinds.

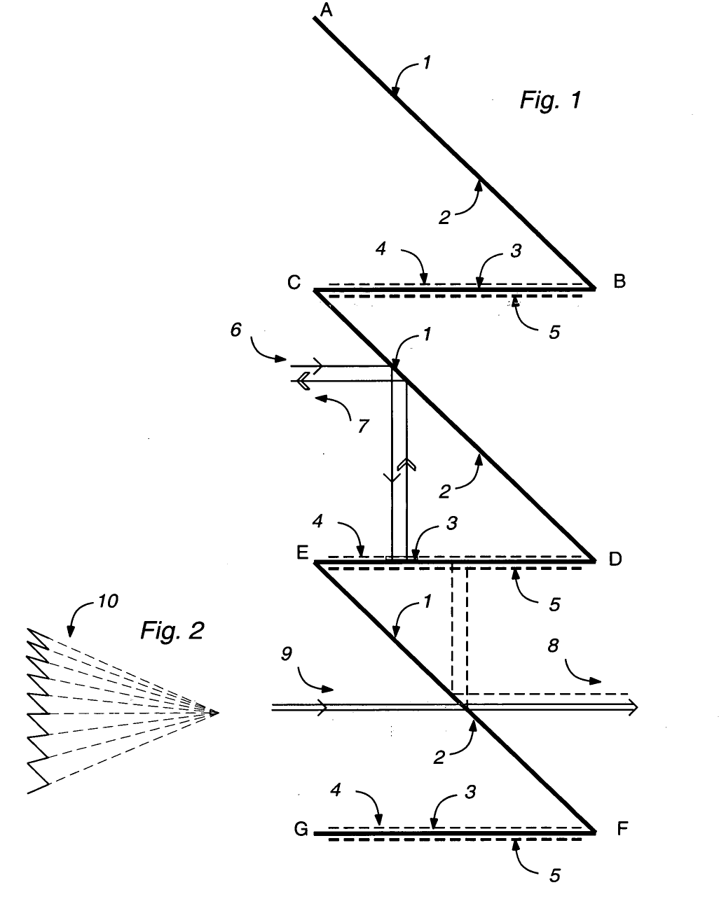

FIG. 1 shows the noseein in cross section:

1) Slat AB. This is repeated as CD, EF, and so on. These slats need not be flat.

2) Translucent mirrored surface.

3) Slat BC. This is repeated as DE, FG, and so on. These slats need not be flat.

4) Matt light reflective and/or light emitting surface. This surface can be with or without a pattern.

5) Matt light absorbing surface. This surface can be black or colored and be with or without a pattern.

6) View looking in with light path directions indicated by single line arrows.

7) Return path of view which is of the matt light reflective and/or light emitting surface.

8) Looking out, the outside view is not obscured by light along the dashed path.

9) Looking out, the outside view is seen as light enters in along the light path indicated by the double line with a single line arrow.

10) FIG. 2 (inset drawing) shows schematically and in cross section the joined slats AB, BC, CD, DE, EF, FG, and so on, as in FIG. 1. The slats that join making angles ABC, BCD, CDE, DEF, EFG, and so on, can be variously curved, do not need to be at 45 degrees as shown in FIG. 1, and can be more or less than that angle and be varied in purposeful ways. No scale is shown as slats pairs as AB and BC can be of any dimensions and can be hung horizontally or vertically or at another angle and lengthwise can be flat, or zigzag or curved.

1. I claim my “noseein” system of slats that occur in repeats of one that is opaque with a light absorbing side and a light reflective or light emitting side and, facing it at an angle, one that is transparent and semi-mirrored, is an original invention in that it is not found in nature, is not elsewhere described, and is nowhere to be found as a once or as an existing installation.
